(19) United States
(12) Patent Application Publication
(10) Pub. No.: US 2009/0067983 A1
(43) Pub. Date: Mar. 12, 2009

(54) Centerline compression turbine engine

(76) Inventor: William R. Estlick, Mashpee, MA (US)

Correspondence Address: William R. Estlick, 24 Porthole Drive, Mashpee, MA, 02649, US

(21) Appl. No.: 11/900,010

(22) Filed: Sep. 10, 2007

(51) Int. Cl. F02K 3/00; F04D 25/16; F04D 19/02

(52) U.S. Cl. 415/91; 415/60; 60/226.1

(57) ABSTRACT

A Centerline Compression Turbofan Engine reconfigures the current technology eliminating the shaft and placing the combustor at the intake of the engine

Turbine blades mounted on the inside of consecutive rings are curved and angled so that they compress air towards the centerline and backward along the axis of the engine as they rotate. High speed exhaust gasses from the combustor coming into contact with the turbine blades provide the rotational drive for each turbine blade array.

Exhaust gasses from the combustion chamber and air from the intake are compressed through consecutively smaller turbine blade arrays along the entire length of the engine until it exits the variable exhaust nozzle.

Said configuration produces a jet of a high speed exhaust gas for propulsive purposes.

### BACKGROUND OF THE INVENTION

This invention is described under class 60, (power plants), subclass 201 (Reaction motor with rotating or cyclic movement during axial thrust).

### BRIEF SUMMARY OF THE INVENTION

The field of the invention relates to a turbofan engine whose use is to propel aircraft by kinetic energy produced by the output of a high speed exhaust gas.

### Current Technology:

The current technology for conventional turbine engines use turbine blades mounted on a shaft; the shaft rotates about the engines' axis. Air is compressed and accelerated by the rotating turbine blades in the compressor stage. Rotational drive for the compressor comes when the accelerated gasses from the combustor encounter turbine blades mounted on the shaft. Air flow striking the angled blades of the turbine causes the shaft to rotate which in turn, rotates the compressor blades.
Inefficiency occurs in the current technology when air flow is interrupted by the turbine blades before it exits the engine.
Inefficiency occurs in the current technology because the turbine blades rotate at the same direction and the same speed as the ones before and after it.
Inefficiency occurs in the current technology because gas is compressed around a shaft, and is only then compressed to the centerline after the last stage of the engine as it passes through the convergent nozzle.
Inefficiency occurs in the current technology because the combustor interrupts the free flow of gas.

### Centerline Compression Turbofan Engine:

A Centerline Compression Turbofan Engine reconfigures the current technology eliminating the shaft and placing the combustor at the intake of the engine. High speed gasses from the combustor are forced through a variable exhaust nozzle along the axis into the centerline of the engine.

Turbine blades are mounted on the inside of rings and radiate inward toward the center of said ring the assemblage here forward called a turbine blade array. Each turbine blade has such a curvature that they compress air towards the centerline and backward along the axis of the engine as they rotate.

Turbine blades coming into contact with the high speed gas flow from the combustor have an angle of attack so that gas flow from the combustor applies force to rotate each turbine blade array. Air and exhaust gasses are compressed through consecutively smaller turbine blade arrays along the entire length of the engine until it exits the nozzle.

Air forced into the intake of the engine as the aircraft accelerates applies additional pressure on the surface of the blades assisting the rotational drive of each consecutive turbine blade array. In addition, compression behind each turbine blade array assists in the rotational drive of the turbine blade array behind it. As the rotation of the turbine blade arrays accelerate to a sufficient speed, the engine then produces a suction that assists in forward motion.

Said configuration will produce a jet of a high speed exhaust gas for propulsive purposes.

### BRIEF DESCRIPTION OF SEVERAL VIEWS OF INVENTION

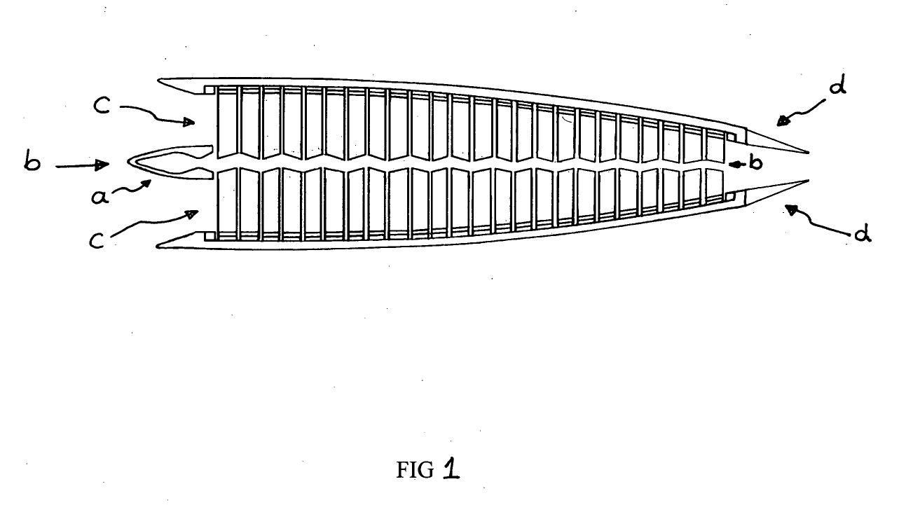

FIG. 1: Centerline Combustion Turbofan Engine cross section.

FIG. 1a depicts the combustor of a Centerline Compression Turbofan Engine. A mixture of compressed air and fuel is injected and ignited in the combustion chamber producing a jet of high speed exhaust gasses that is then directed through the variable exhaust nozzle into the engines centerline along its axis. Supports mounted inside the intake cowling hold the combustor in place. (Supports for the combustor not shown for clarity).

FIG. 1b shows the centerline of the engine through which high speed exhaust gas from the combustor travels through; the peripheral of the combustors high speed exhaust stream applies force to the tip of each turbine blade. The tip of each turbine blade is angled so that as it comes into contact with the combustors exhaust stream; the pressure on the blades provides force to rotate each turbine blade array.

FIG. 1c depicts the turbine blade array at the intake of the engine with its turbine blades radiating around the center affixed to the inside of rings. Each turbine blade has a curvature so that as the turbine blade array rotates, air is forced backwards along the axis of the engine and inward towards the centerline. The tips of each turbine blade are concaved to shape the centerline gases into a cylindrical shape about the engines axis.

FIG. 1d depicts the variable exhaust nozzle of the engine. High speed exhaust gasses from the centerline provide thrust for forward motion. Compressed air that has not been compressed into the centerline also exits the engine here providing additional thrust. A variable exhaust nozzle further regulates compression of exiting gasses as well as providing a means of regulating internal pressures of the engine.

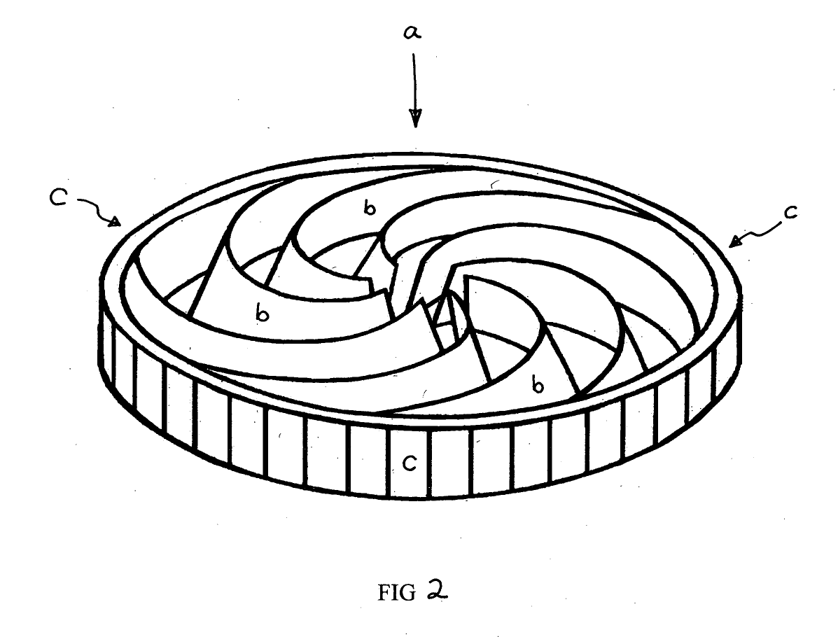

FIG. 2: Turbine Blade Array.

FIG. 2a depicts the centerline of a turbine blade array through which the jet of high speed exhaust gas from the combustor and compressed air are accelerated through the centerline and toward the back of the engine. The tip of each turbine blade extends into the path of the centerline gas flow at an angle.

FIG. 2b shows a turbine blade having a curvature so that as it rotates, air is forced backwards along the engines axis and toward the engines centerline simultaneously.

FIG. 2c depicts the ring of a turbine blade array. Each ring is held in place inside the casing and away from each other with magnets or bearings. Turbine blades radiate inward toward the center of the ring.

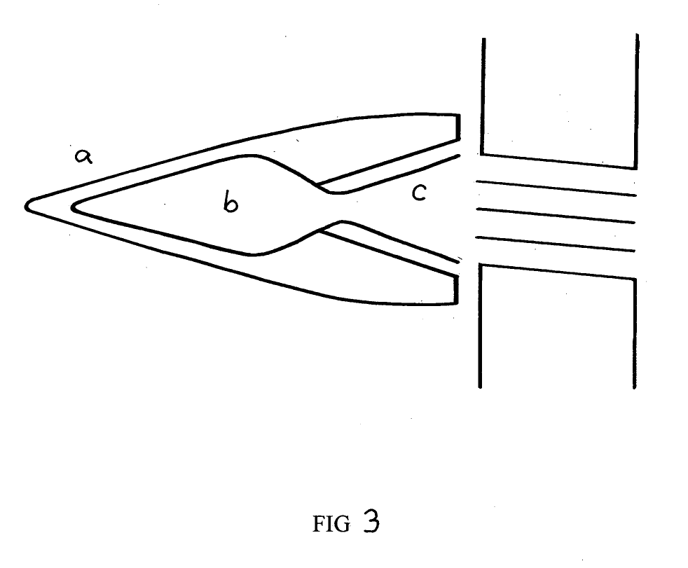

FIG. 3: Combustor.

FIG. 3a shows the cone shaped combustor which minimizes resistance as the engine moves through the air and also facilitates compression and air flow into the intake. The combustor is held in the center of the intake by supports attached to the intakes cowling. (Supports not Shown for Clarity)

FIG. 3b is the combustion chamber. A mixture of compressed air and fuel is injected into the combustion chamber and burned. Hot gasses expand and are forced out a variable exhaust nozzle into the centerline of the engine.

FIG. 3c is the variable exhaust nozzle that directs the flow of high speed exhaust gas into the centerline of the engine. It also regulates the pressure inside the combustors combustion chamber and controls the characteristics of the gas flow into the engine.

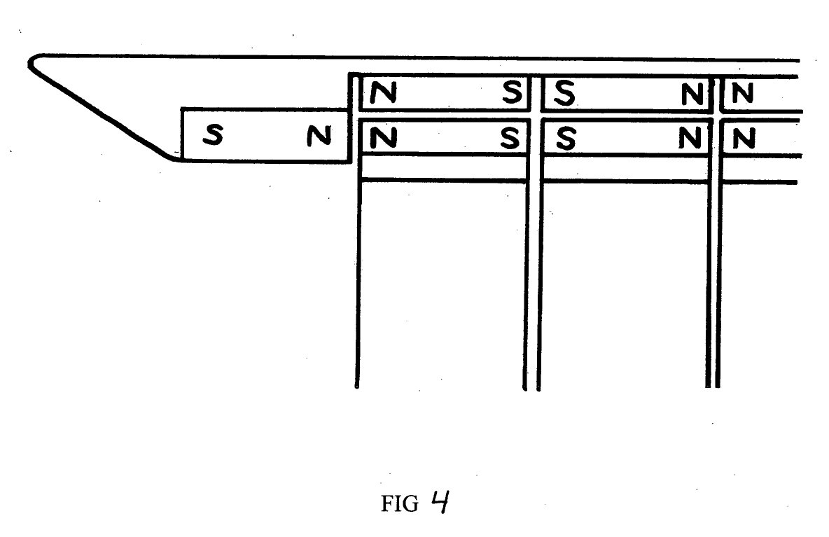

FIG. 4: introduces the concept for Magnetic Bearings.

FIG. 4 is a cross sectional view of the intake of the engine; Magnets or a magnetized material is attached on the inside of the casing and on the outside of each turbine blade array ring. The polarizations of the magnets are arranged so that they repel each other and hold the turbine blade array away from the casing and away from the turbine blade array on each side. This eliminates contact and friction from the rotating rings. Magnets lining the casing keep it from touching the casing. Magnets around the inside edge of the intake cowling as well as before the convergent nozzle hold all the rings in place.

### DESCRIPTION OF THE PREFERRED EMBODIMENT

### Combustor:

The current technology of a turbofan engine uses a combustor located at about the middle of the engine and provides power by turning turbines mounted on a shaft. Fuel is injected into the compressed air stream in the combustor and burned. This heats, expands and accelerates the air. Rotational drive for the compressor stage comes when the accelerated gasses encounter turbine blades mounted on the shaft. Gas flow from the combustor striking the angled blades of the turbine causes the shaft to rotate which in turn, rotates the compressor at the beginning of the engine.

A Centerline Compression Turbofan Engines combustor is mounted in the intake at the beginning of the engine with its exhaust gasses directed in line with the axis of the engine. Air and fuel lines travel through the supports that hold the combustor to the center of the intake cowling. Compressed air from a centrifugal compressor, intake scoop, bled from the engine or a combination there of is mixed with fuel and ignited in the combustion chamber.

The variable exhaust nozzle of the combustors high speed exhaust gas is directed into the centerline of the engine. This applies force on the angled tip of the turbine blades providing the rotational drive for each turbine blade array.

The configuration of the combustor is reminiscent of a rocket engine and its construction and materials may be the same.

### Turbine Blade Array:

The current technology for conventional turbofan engines uses turbine blades mounted on a shaft. As the shaft rotates about the axis of the engine, air is compressed and accelerated by the turbine blades in the compressor stage.

A Centerline Compression Turbofan Engines turbine blades are mounted on the inside of rings to form turbine blade arrays; its blades radiate inward toward the center of said ring. These turbine blade arrays are cast or milled out of a strong, lightweight and heat resistant material such as titanium, ceramic, alloy or composite. Magnets or bearings are mounted on the outside of each ring and each ring rotates freely and independently. The direction of a turbine blade arrays rotation is dependant on turbine blade orientation.

### Turbine Blade:

Turbine blades may be milled or cast with the ring as one piece or fabricated separately and then attached to the ring. Each turbine may be straight or have a curvature so that as they rotate, they compress gasses into the centerline and backward along the engines axis. The tip of each turbine blade radiates inward toward the engines' centerline having an angle of attack so that as the jet high speed gas from the combustor strikes the tips of the turbine blades turning the turbine blade array. The tip of each turbine blade does not extend entirely into the centerline leaving a hole to allowing the free flow of gas through the entire length of the engine.

### Variable Exhaust Nozzle:

A variable exhaust nozzle or convergent nozzle is mounted to the casing as the last stage of the engine. It may be of the same construction and materials as the current technology. The nozzle restricts the flow controlling the internal pressure of the engine as well as the exhaust characteristics.

### Engine Casing:

The engine casing may be made of a variety of strong, lightweight, heat resistant materials or composite. Its design and function is to hold the assembled components in place. It also holds the bearings or magnets, intake cowling and nozzle. It will also support the engine mount, sensors and other support equipment.

1. A turbofan engine consisting of a series of freely and independently rotating rings having turbine blades radiating inward towards the center of said rings and the centerline of said engine.
(1a) the turbofan engine of claim 1 having a combustion chamber mounted at the intake of said engine with its exhaust gases directed in line with the axis.
(1b) the turbine blades of claim 1 have an angle of attack so that when the exhaust gasses from the said combustion chamber applies force on said turbine blades providing rotational drive for each turbine blade array.
(1c) the turbine blades of claim 1 have an angle of attack so that as each turbine blade array rotates, the said turbine blades compress gasses backward along the turbofan engines axis. K
(1d) the turbine blades of claim 1 do not extend all the way to the center of the ring allowing the free flow of gas through the centerline of the said turbofan engine.

2. A turbofan engine that works by compressing air into the centerline and backward along the axis of said engine to produce a jet of a high speed exhaust gas for propulsive purposes.
(2a) the turbofan engine of claim 2 uses a series of rings having turbine blades mounted on the inside of said rings radiating inward toward the centerline here forward called turbine blade arrays.
(2b) the turbine blades of claim 2 have a curvature so that they compress gasses into the centerline and backward along the engines axis as the said turbine blade array rotates.
(2c) the turbofan engine of claim 2 uses consecutively smaller said turbine blade arrays and centerline openings aiding in compression.
(2d) the turbine blades of claim 2 uses do not extend into the centerline of the engine allowing for the unobstructed flow of gas through the entire length of the engine.
(2e) the turbine blade arrays of claim 2 rotate freely and independently.
(2f) the turbine blade arrays of claim 2 alternately rotate in opposite directions providing improved compression and efficiency over the current technology.
(2g) the turbine blade arrays of claim 2 direction of rotation is dependant on its said turbine blade array orientation.
(2h) the turbine blade arrays of claim 2 are held in place inside the casing and away from each other using magnetic or conventional bearings.
(2i) the turbofan engine of claim 2 uses a combustion chamber mounted in the center of the intake cowling with its thrust in line with the axis of said engine.
(2j) the combustion chamber of claim 2 uses a variable exhaust nozzle to control the characteristics of said combustion chambers exhaust gas flow
(2k) the combustor of claim 2 uses compressed air from a centrifugal compressor, intake scoop or bled from the engine and is mixed with fuel in said combustion chamber.
(2l) the turbine blades of claim 2 come in contact with the high speed exhaust gas from said combustor to provide the rotational force to drive each turbine blade array.
(2m) the turbine blades of claim 2 have a concave tip to shape the flow of gasses around the centerline into a cylindrical shape as it rotates about the centerline.
(2n) the turbofan engine of claim 2 uses a variable exhaust nozzle to regulate exhaust gasses.
(2o) the variable exhaust nozzle of claim 2 provides a means for regulating internal pressures within said turbofan engine.
(2p) the variable exhaust nozzle of claim 2 provides a means for regulating the exhaust gasses of said turbofan engine.
